(19) United States
(12) Patent Application Publication
(10) Pub. No.: US 2016/0283606 A1
(43) Pub. Date: Sep. 29, 2016

(54) METHOD FOR PERFORMING WEBPAGE LOADING, DEVICE AND BROWSER THEREOF

(71) Applicant: BEIJING QIHOO TECHNOLOGY COMPANY LIMITED, Beijing (CN)

(72) Inventors: Peng XIONG, Beijing (CN); Tianping WANG, Beijing (CN); Hongyi ZHOU, Beijing (CN)

(21) Appl. No.: 15/022,547

(22) PCT Filed: Sep. 12, 2014
(86) PCT No.: PCT/CN2014/086435

§ 371 Date: Mar. 16, 2016

(30) Foreign Application Priority Data
Sep. 17, 2013 (CN) 201310425624.3

(51) Int. Cl. G06F 17/30; G06F 17/21; G06F 17/22

(52) U.S. Cl. CPC G06F 17/30905; G06F 17/30896; G06F 17/2247; G06F 17/211

(57) ABSTRACT

The disclosure provides a method for performing webpage loading, comprising: obtaining HTML text of a current request-to-load webpage at a browser side; detecting a tag for specifying a browser kernel included in the HTML text of the webpage; using the browser kernel specified by the tag to load the current requested webpage. In the disclosure, a tag for specifying browser kernel is disposed in the HTML text of a webpage. When it is needed to load the webpage, if the tag for specifying browser kernel is detected in the HTML text of the webpage, the browser kernel specified by the tag is used to load the webpage. In the disclosure, the compatibility and adaptability of browsing webpages in different environments are improved without affecting the user's normal usage of the browser. At the same time, the user's manual switching kernel and the browser's detecting webpage and selecting kernels are avoided.

### CROSS-REFERENCE TO RELATED APPLICATIONS

This application is the national stage of International Application No. PCT/CN2014/086435 filed Sep. 12, 2014, which is based upon and claims priority to Chinese Patent Applications No. CN201310425624.3, filed Sep. 17, 2013, the entire contents of which are incorporated herein by reference.

### FIELD OF TECHNOLOGY

The disclosure relates to the field of browser and, particularly to a method for performing webpage loading, a device for performing webpage loading and a browser.

### BACKGROUND

A browser may be divided into two parts in architecture, which are kernel and shell. The browser kernel refers to the core part of the browser, which may be divided into to two part: a layout engineer (or Rendering engine) and a JavaScript (JS) engine. The layout engineer mainly takes charge of obtaining content of webpage (including HTML, XML, images and so on), collating information (such as adding cascading style sheets (CSS) and so on), and calculating the display way of webpage, and then outputting the webpage to display or printer. Different browser kernel may lead to different grammar explanation of webpage, thusly the rendering effect may also be different. All the webpage browser, Email client side and other application which need to edit and display network content need kernel. JS engine is used to parse JavaScript language, execute JavaScript language to obtain dynamic effect of the webpage.

There are various kinds of browser kernel. the commonly-seen browser kernel is Trident kernel used by IE browser from Microsoft, Gecko kernel used by Firefox browser, Webkit kernel used by Safari browser from Apple and chrome browser from Google, and Presto kernel used by Opera browser.

When a user initiate a request for browsing webpage via the browser, the browser downloads content of target webpage, and then analyzes webpage content, executes script, calculates webpage layout, and at last outputs the content to the display to display to the user. Each browser has a kernel, the browser uses the same kernel to perform interpretive execution no matter how many webpages the user opens via one browser process.

However, the single-kernel browser has great limitation. That is because the webpage is usually made according to one network standard supported by certain kernel, other kernels may not support the network standard supported by certain kernel well (or even cannot support the network standard). For example, when the user uses Firefox browser to browse webpage, the browser kernel of Firefox may well support W3C standard, thusly using the browser may browse webpages made according to W3C standard. However, if the user wants to browse webpage of China Merchants Bank and use network bank, Firefox browser cannot satisfy the user requirement because network bank function of China Merchants Bank website needs ActiveX plug-in function, the function may only be supported by IE browser kernel. Thusly the user cannot use network bank function of China Merchants Bank when he or she uses Firefox browser.

### SUMMARY

In view of above problems, the disclosure is proposed to provide to a method for performing webpage loading and a device for performing webpage loading correspondingly, and a browser.

According to an aspect according to the disclosure, there is provided a method for performing webpage loading, comprising:
obtaining HTML text of a current request-to-load webpage at a browser side;
detecting a tag for specifying a browser kernel included in the HTML text of the webpage;
using the browser kernel specified by the tag to load the current requested webpage.

Alternatively, the tag for specifying the browser kernel is a meta tag, the meta tag comprises a key value, which includes name information used as a key, and content information used as a value, the name information is configured to indicate information of the browser kernel, the content information is configured to indicate information for specifying browser kernel.

According to another aspect of the disclosure. There is provided a device for performing webpage loading, comprising:
a HTML text obtaining module, configured to obtain HTML text of a current request-to-load webpage at a browser side;
a tag detecting module, configured to detect a tag for specifying a browser kernel included in the HTML text of the webpage;
a first loading module, configured to use the browser kernel specified by the tag to load the current requested webpage.

According to still another aspect, there is provided a browser, comprising:
a HTML text obtaining module, configured to obtain HTML text of a current request-to-load webpage at a browser side;
a tag detecting module, configured to detect a tag for specifying a browser kernel included in the HTML text of the webpage;
a first loading module configured to use the browser kernel specified by the tag to load the current requested webpage.

According to another aspect, there is provided a computer program, comprising computer readable codes, wherein when the computer readable codes are carried out on an electronic apparatus, the electronic apparatus executes the method for performing webpage loading above.

According to another aspect, there is provided a computer readable medium, in which the computer program above is stored.

The beneficial effect of the disclosure lies in:

In the disclosure, a tag for specifying browser kernel is disposed in the HTML text of a webpage. When it is needed to load the webpage, if the tag for specifying browser kernel is detected in the HTML text of the webpage, the browser kernel specified by the tag is used to load the webpage. In the disclosure, the compatibility and adaptability of browsing webpages in different environments are improved without affecting the user's normal usage of the browser. At the same time, the user's manual switching kernel and the browser's detecting webpage and selecting kernels are avoided, which is convenient for the user's operation, reduces the occupation of browser resource and improves webpage loading efficiency.

In another aspect, in the disclosure, at least two kernels are integrated in one browser, based on the advantages and disadvantages of each kernel, the multi-kernel browsers may have improved success rate in loading webpages compared with single-kernel browsers. In addition, the multi-kernel browsers in the embodiment of the disclosure may select adapted browser kernels for user-browsed webpages initially according to preset rules, instead of selecting browser kernel for loading the webpage by the user himself or herself blindly, the blindness of user selecting may be avoided in certain extent, and the success rate in loading webpage may be further improved.

Described above is merely an overview of the inventive scheme. In order to more apparently understand the technical means of the disclosure to implement in accordance with the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the disclosure. Further, throughout the drawings, same elements are indicated by same reference numbers. In the drawings:

FIG. 1 is a flow chart schematically showing the method for performing webpage loading according to the first embodiment of the disclosure.

FIG. 2 is a flow chart schematically showing the method for performing webpage loading according to the second embodiment of the disclosure.

FIG. 3 is a block diagram schematically showing the device for performing webpage loading according to an embodiment of the disclosure.

FIG. 4 is a block diagram schematically illustrating an electronic apparatus for executing the method according the disclosure; and

FIG. 5 is a schematically diagram showing a memory unit which is used to store and carry program codes for realizing the method according to the disclosure.

### DESCRIPTION OF THE EMBODIMENTS

Exemplary embodiments of the present disclosure will be described in detail with reference to the accompanying figures hereinafter.

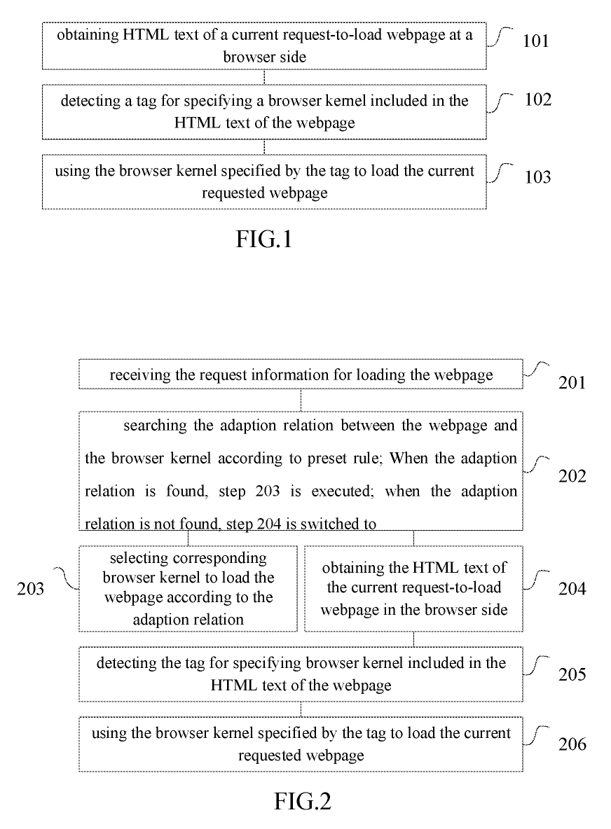

As shown in FIG. 1, it is a flow chart schematically showing the method for performing webpage loading according to the first embodiment of the disclosure. The method may include the following steps:

Step 101, obtaining HTML text of a current request-to-load webpage at a browser side;

HTML (Hypertext Markup Language) is a coding language in establishing Web hypertext document, it may indicate how the Web browsing application displays information of Web document (that is, the webpage), and how it links various kinds of information. Using HTML text may contain other documents in the document generated in HTML text, or contain images, sounds, videos and so on, to form Hyper text.

A browser refers to a kind of software which may display HTML text of webpage server or document system, and allow the user to have interaction with these files. The browser mainly uses Hypertext transfer protocol (HTTP) to perform interaction with webpage server and obtain webpage, these webpages are specified by universal resource locator (URL) with HTML file format, and are specified in HTTP protocol by multipurpose Internet mail extensions MIME. One webpage may include multiple documents, and each document is obtained from the server, respectively.

Many browsers may support various of formats except for HTML, such as image formats of JEPG PNG GIF and so on, and may extend to support various plug-ins. In addition, may browsers may also support other URL type and the corresponding protocols such as file transfer protocol (FTP), Gopher, HTTPS (encrypted version of HTTP).

HTTP content type and URL protocol specification allow the webpage designer to embed images, animations, videos, sounds, streaming videos and so on.

The process that the browser loads and renders HTML text may be as follows:
1. When the URL (assuming the user visits a HTML webpage, and the webpage is visited for the first time) entered by the user is detected, the browser sends a request to the server to load the webpage indicated by the URL, and the server feeds back corresponding HTML text;
2. The browser starts to load source code of HTML text, when detects the <head> tag includes a <link> tag inside, it is needed to quote external CSS file;
3. The browser sends a request to the server about the CSS file, the server feeds back the corresponding CSS file;
4. The browser keeps loading code in the <body> part of the HTML text, at that moment, the CSS file is received, and it is capable to start render the webpage;
5. When the browser detects an <img> tag in the HTML text, it is needed to quote an image, and the browser sends a request for loading image to the server. At that moment, the browser does not need to wait the finishing of downloading the image, instead, it continues rendering the code below;
6. The server feeds back the image file, since the image occupies certain area, paragraph arrangement in the below is affected, thusly the browser needs to re-render these part of code.
7. When the browser detects a <script> tag including a line of Javascript code, then it runs immediately;
8. The Javascript is used to execute the above statement, it orders the browser to hide a certain <div> (style.display=“none”) in the code, since there is a lack of <div> element, the browser needs to re-render this part of code.
9. When the </html> is detected, the rendering is finished;
10. When the user clicks the “change skin” button in the interface, Javascript orders the browser to change the CSS route of the <link> tag;
11. The browser uses each of the elements such as <div>, <span>, <ul>, <li>, and requests for new CSS file from the server, and re-renders the webpage.

Step 102, detecting a tag for specifying a browser kernel included in the HTML text of the webpage;

Using the embodiment of the disclosure, during editing the webpage, the website developer may use the tag of the HTML text to specify the browser kernel which is needed during loading the webpage developed by him or her. Based on the understanding of the website developer to the webpage he or she develops, the browser kernel specified by him or her may make the webpage loading optimal.

In a preferred embodiment of the disclosure, the tag for specifying browser kernel may be a meta tag, the meta tag may include a key value, which includes name information used as a key, and content information used as a value, the name information is configured to indicate information of the browser kernel, the content information is configured to indicate information for specifying browser kernel.

Specifically, in the header information of HTML, the start and end of the header information may be represented by two tags of <head> and </head>, respectively. The tags which may be included in the header information may be the content such as title, preamble, description and so on. The header information itself may not be displayed as content, but may affect the display effect of the webpage. Usually, the most commonly-used tag in the header information is title tag and meta tag.

The meta tag is a code in the HTML text of webpage, it may be used to describe an attribute of the HTML text such as author, date and time, webpage description, key words, webpage refreshing and so on.

By using the embodiment, the meta tag may be used to indicate the browser kernel specified to load the current requested webpage.

In actual application of the embodiment, the meta tag may include name and content. The name may be renderer, that is used to render the browser kernel. The value of content is used to indicate corresponding browser kernel. It should be noted that, the value of the content may be any string of code which represents the browser kernel. For example, 1 represents Webkit kernel, 2 represents Trident kernel and so on, the disclosure is not limited thereto. Preferably, the content may include value that is used to indicate Webkit kernel, IE-com kernel (compatible to IE kernel) and/or IE-stand kernel. For example, when the meta tag is<meta name=“renderer” content=“webkit”>, it is indicated to render Webkit kernel of the browser. Obviously, during performing the embodiment of the disclosure, it is also capable to dispose other browser kernels according to actual situations, such as Presto kernel and Presto kernel, the embodiment of the disclosure is not limited thereto.

Step 103, using the browser kernel specified by the tag to load the current requested webpage.

It should be noted that, when the current browser is integrated with browser kernel specified by the tag, it is capable to use the browser kernel specified by the tag to load the currently requested webpage.

In a preferred embodiment of the disclosure, step 103 may include sub-steps as follows:
Sub-step S11, extracting the content information of the meta tag;
Sub-step S12, determining whether the preset default browser kernel is the same as the browser kernel specified by the content information; if yes, executing sub-step S13; if not, executing sub-step S14;
Sub-step S13, using the default browser kernel to load the current requested webpage;
Sub-step S14, switching the default browser kernel to the browser kernel specified by the content information, using the specified browser kernel to load the current requested webpage.

In actual application, it is capable to detect the header information of the HTML, and obtain the meta tag. When the name of meta tag is information of indicating the browser kernel, such as render, it is capable to extract the content information in the meta tag, when the browser kernel indicated by the content is current defaulted browser kernel (that is the browser kernel when loading the webpage currently), continue using current default browser kernel to load the web page. When the browser kernel indicated by the content is not the current default browser kernel, the current default browser kernel is set to be the browser kernel indicated by the content, and then the current webpage is loaded.

Obviously, the above loading method is only taken as an example. In executing the embodiment of the disclosure, it is capable to dispose other loading method according to actual loading method. For example, directly switching the default browser kernel to the browser kernel indicated by the content information without determination, using the specified browser kernel to load the current requested webpage and so on, the embodiment of the disclosure is not limited thereto. In addition, besides the loading method above, a skilled person in the art may also use other determination and processing method according to actual requirement. The embodiment of the disclosure is also not limited thereto.

In the disclosure, a tag for specifying browser kernel is disposed in the HTML text of a webpage. When it is needed to load the webpage, if the tag for specifying browser kernel is detected in the HTML text of the webpage, the browser kernel specified by the tag is used to load the webpage. In the disclosure, the compatibility and adaptability of browsing webpages in different environments are improved without affecting the user's normal usage of the browser. At the same time, the user's manual switching kernel and the browser's detecting webpage and selecting kernels are avoided, which is convenient for the user's operation, reduces the occupation of browser resource and improves webpage loading efficiency.

As show in FIG. 2, it is a flow chart schematically showing the method for performing webpage loading according to the second embodiment of the disclosure. The method may specifically include the following steps:

Step 201, receiving the request information for loading the webpage;

the request information for loading the webpage may be referred to an indication of loading certain webpage sent from a user. For example, the user may click certain link to open a webpage, or may input URL in the address bar to open a website. When obtaining the indication that the user clicks a certain link, it means the request information from the user to load the webpage is received; similarly, when the user inputs a certain URL in the address bar and clicks “yes” button or “enter” button, it also means the request information from the user to load the webpage is received.

Wherein, the content of the request information may include the identification and/or characteristic of the request-to-load webpage from the user. The webpage identification may represent a unique determined webpage information, such as the uniform resource identifier (URI), or uniform resource name (URN) and so on.

Step 202, searching the adaption relation between the webpage and the browser kernel according to preset rule; When the adaption relation is found, step 203 is executed; when the adaption relation is not found, step 204 is switched to;

In actual application, the methods for obtaining the adaption relation between the user requested webpage and the browser kernel are various, they are illustrated hereinbelow.

In the first method, it is capable to obtain the adaption relation between the user requested webpage and the browser kernel according to the content obtained from the request information and the preset rule.

Detaildly, the preset rule may include specific adaption rules, general adaption rules and/or non-adaption rules. During the process of requesting to load the webpage, the adaption relation between the user requested webpage and the browser kernel may be obtained according to the specific adaption rules, general adaption rules and/or non-adaption rules. Wherein the specific adaption rules may include the adaption relation between webpages and kernels, the general adaption rules may include selecting the browser kernel whose average loading speed is the fastest for the user, or selecting the browser kernel which supports the web standard best. The non-adaption rule may include the non-adaption relation between the webpages and the kernels.

Since the browser may also send the loading request information about loading webpage to the corresponding server according to the received request information, the server may feed back response information specific to the loading request information, and the response information may carry information such as webpage content of the webpage, under this circumstance, it is also capable to re-obtain the browser kernel that is adaptive to the user requested webpage according to the obtained content from the response information specific to the loading request information from the server and preset rule; if the re-obtained adapted browser kernel is different from the adapted browser kernel which is previously obtained based on the request information, it is capable to select the re-obtained adapted browser kernel to load the user requested webpage.

In the second method, since the browser may send the loading request information about loading webpage to the server according to the received request information, the server may feed back response information specific to the loading request information, and the response information may carry information about webpage content of the webpage, therefore in the method, it is capable to obtain the adaption relation between the user requested webpage and the browser kernel directly according to the obtained content in the response information feedback specific to the loading request information feedback from the server and the preset rule.

Obviously, it is also capable obtain the adaption relation between he user requested webpage and the browser kernel both according to the obtained content from the request information and the obtained content in the response information feedback specific to the loading request information feedback from the server and the preset rule.

In addition, when using the method in each embodiment to load the webpage (which may be during the loading process and after the loading process), it is also capable to detect the condition of loading the user requested webpage; if the condition that the preset kernel needs to be switched is found, it is capable to re-obtain the browser kernel adapted to the webpage according to the preset rule, and uses the re-obtained browser kernel to load the user-requested webpage. Wherein the condition that the preset kernel needs to be switched may include: it is detected that the loading speed is low during loading, or it shows that the webpage is not displayed normally after the load is finished, and so on.

In a preferred embodiment of the invention, the step 202 may include the following sub-steps:

Sub-step S21, obtaining the browser kernel adapted to the request-to-load webpage according to the preset rule;

In the embodiment, it is the browser kernel that is adapted to the user requested webpage that may be obtained. Therefore, the browser kernel adapted to the user requested webpage may be invoked to load the user requested webpage. The browser in the embodiment may be a multi-kernel browser, that is the browser may include at least two kinds of browser kernels. Since each kind of browser kernel corresponds to a piece of code, the multi-kernel browser realizes multiple pieces of code in the browser, when certain browser kernel is used to load the webpage, the corresponding code is invoked.

And/or

Sub-step S22, loading browser kernel not adapted to the requested-to-load webpage according to the preset rule.

In the embodiment, it is the browser kernel that is not adapted to the user requested webpage that may be obtained. Therefore, the browser kernel out of the browser kernels which are not adapted to the user requested webpage may be selected to load the user requested webpage. Detailedly, any browser kernel out of the not adapted browser kernels may be used to load the user requested webpage. For example, the browser includes a browser kernel A, B and C, it is obtained that the user requested webpage is not adapted to the browser kernel A, then, any of the browser kernels B and C may be selected to load the webpage.

In addition, it is also capable to obtain the browser kernel adapted to the user requested webpage and the browser kernel not adapted to the user requested webpage, and then the browser kernel adapted to the user requested webpage is selected to load the user requested webpage. For example, the browser includes browser kernels A, B and C, it is obtained that the browser kernel A is not adapted to the user requested webpage, and the browser kernel C is adapted to the user requested webpage, then the browser kernel C is selected to load the webpage.

Step 203, selecting corresponding browser kernel to load the webpage according to the adaption relation;

After selecting the browser kernel adapted to the user requested webpage according to the obtained content from the request information and the preset rule, it is capable to load the user requested webpage by invoking the selected browser kernel adapted to the user requested webpage.

In a preferred embodiment of the disclosure, step 203 may include the following sub-steps:
sub-step S31, selecting the browser kernel adapted to the requested-to-load webpage to load the webpage;
and/or,
sub-step S32, selecting other browser kernel out of the non-adapted browser kernel to load the webpage;
correspondingly, the sub-step S31 may be performed after sub-step S21, or sub-step S32 may be performed after sub-step S22, or sub-step S31 and sub-step S32 may be performed after sub-step S21 and sub-step S22 are performed.

In actual realization, when the content obtained by the request information includes webpage identification such as webpage URL, it is capable to select the browser kernel adapted to the user requested webpage according to preset specific adaption rule. The preset specific adaption rule may include the adaption relation between the URL and the browser kernel, for example, the specific adaption rule may be a black list and/or white list, the stored adaption relation may be in various forms, such as in item form. Hereinafter, the black list, the white list and webpage URL are taken as example to illustrate. For example, a white list may be pre-stored, which records the adaption between webpages and browser kernels, the webpages may be represented by webpage URL, furthermore, when the webpage URL is obtained from the request information, it is capable to find the browser kernel corresponding to the webpage URL from the white list, and then take the browser kernel is determined to be adapted to the user requested webpage. In another example, a black list may be pre-stored, which records the non-adaption between webpages and browser kernels, when the webpage URL is obtained from the request information, when selecting the browser kernel, it is capable to exclude the non-adapted browser kernel. It should be noted that, the black list and the white list do not need to exist at the same time, that is, it is capable to select browser kernel adapted to user requested webpage according to the black list (that is the other kernels out of the non-adapted browser kernels recorded in the black list are considered to be the browser kernel adapted to the webpage); and it is also capable to select the browser kernel adapted to the user request-to-load webpage according to the white list, in addition, the black list and the white list may co-exist, as long as they are differentiated.

Wherein the adaption relation recorded in the list may be obtained according to conventional experience and/or inherent feature of the specified browser kernel and/or inherent feature of the specific webpage and other aspects. For example, if it is found that the speed for loading a certain webpage is fastest when a browser kernel A is used, (the loading speed being the fastest when the kernel A is used may be because the webpage includes large amount of script files, and the browser kernel A has the characteristic that it can explain script file in the highest speed), then a record is added to the white list, in the record, the webpage URL corresponds to the browser kernel A, then, when selecting kernel for this webpage, browser kernel A may be selected directly. Taking another example, when it is found that certain webpage may be loaded best using browser kernel B, the white list then records the corresponding relation between the webpage URL and the browser kernel B, then, when selecting kernel for this webpage, the browser kernel B may be directly selected. Taking still another example, based on the inherent feature of the webpage and the browser kernel, it is obtained that certain webpage is compatible with browser kernel A but not compatible with browser kernel C, thusly, the white list may record the webpage URL corresponds to the browser kernel A, then, when selecting the browser kernel for the webpage, kernel A may be selected directly; obviously, it is also capable to record in the black list that the webpage URL corresponds to the browser kernel C, then when selecting the kernel for the webpage, other browser kernel out of browser kernel C may be selected. Furthermore, for example, when it is found that certain webpage cannot be displayed normally when using the browser kernel D to load, a record may be added to the black list, in the record, the webpage corresponds to the browser kernel D, and when selecting kernel form the webpage, other browser kernels out of the browser kernel D may be selected, and so on. The browser kernels A, B, C and D mentioned in the above examples may be the same or different, that is, different webpages are allowed to correspond to the same browser kernel.

In addition, it is also capable to record the adaption relation between certain type of webpages and certain browser kernel in the black list and/or white list. For example, usually all webpages under a domain name have accordant attribute (for example, 360.com is a domain name, all the webpages under this domain name have similar attribute), that is, generally this kind of webpages may be loaded by the same browser kernel. During specific realization, it is capable to use part content in certain webpage URL (such as the domain name in the webpage) as feature information of certain type of webpages to correspond to the browser kernel, then, the adaption relation between the feature information representing one type of webpages and the browser kernel may be recorded in the black list and/or white list. Then, when the request information of the user request-to-load webpage is received, whether the content representing the feature information of a certain type of webpages (such as the domain name of URL) is in the black list/white list is searched, then the adapted browser kernel may be searched according to the feature information (such as domain name) of the webpage.

It should be noted that, whether the webpage is compatible with certain browser kernel and whether the webpage can be displayed normally under certain browser kernel may be found according to the browser kernel and the inherent feature of the webpage, and they may also be found by the user. That is, an interface may be provided to the user to report the non-compatible or abnormal display to the server corresponding to the browser, then, the information is collated and recorded and pushed to each browser.

In addition, when selecting the browser kernel adapted to the user requested webpage according to the content obtained in the request information and the preset rule, it is also capable to select the browser kernel adapted to the user request-to-load webpage according to the preset general adaption rule. The general adaption rule may include adaption rule which is not formed based on particular webpage, for example, selecting browser kernel which has fastest average loading speed for the user, or selecting browser kernel which supports the network standard best for the user.

Each browser kernel has its characteristic, and these characteristics may be obtained and recorded by pre-test. For example, the average loading speed may be different, according to the test under the same condition, the time that the kernel of Presto executes the same Javascript is ⅓ of that the kernel of Trident and the kernel of Gecko. In addition, the good or bad degree of the browser kernel supports the network standard may also be obtained by test. For example, the kernel of Trident does not support well to W3C standard, and the Gecko, the WebCore, the Presto meet each kind of international standard better. As a result, when selecting browser kernel using each kind of general adaption rules, it is capable to select according to the recorded features.

It should be noted that, the previous illustrated specific adaption rule and general adaption rule may be used alone or combined together. For example, it is capable to first select the browser kernel adapted to the user requested webpage according to specific adaption rule, when it is found that selecting the browser kernel adapted to the webpage by specific adaption rule is not proper (for example, the URL of certain webpage is not in the black list or the white list), it is further capable to select according to the general adaption rule. Taking a specific example, if it is found that the URL of webpage A is not in the black list or the white list, it is capable to select the browser kernel which has the fastest average loading speed or the browser kernel that supports the network standard best (such as the network standard made by W3C including HTML/XHTML, CSS and so on).

When it is not capable to select the browser kernel adapted to the user requested webpage according to the obtained request information and the preset rule, it is capable to directly use default browser kernel to load the user requested webpage.

Step 204, obtaining the HTML text of the current request-to-load webpage in the browser side.

Step 205, detecting the tag for specifying browser kernel included in the HTML text of the webpage;

Step 206, using the browser kernel specified by the tag to load the current requested webpage.

In the disclosure, by integrating at least two kernels in a browser, based on the advantage and disadvantage of each kernel, the success rate for the browser to load webpage is improved compared with single-kernel browsers. In addition, since there are multiple kernels in the browser according to the embodiment of the disclosure, it is capable to select adapted browser kernel for the user visited webpage according to the preset rule, rather than selecting the browser kernel for loading the webpage by the user blindly, thusly, the users selecting blindly by themselves are avoided in certain extent, and the success rate of loading the webpages is further improved.

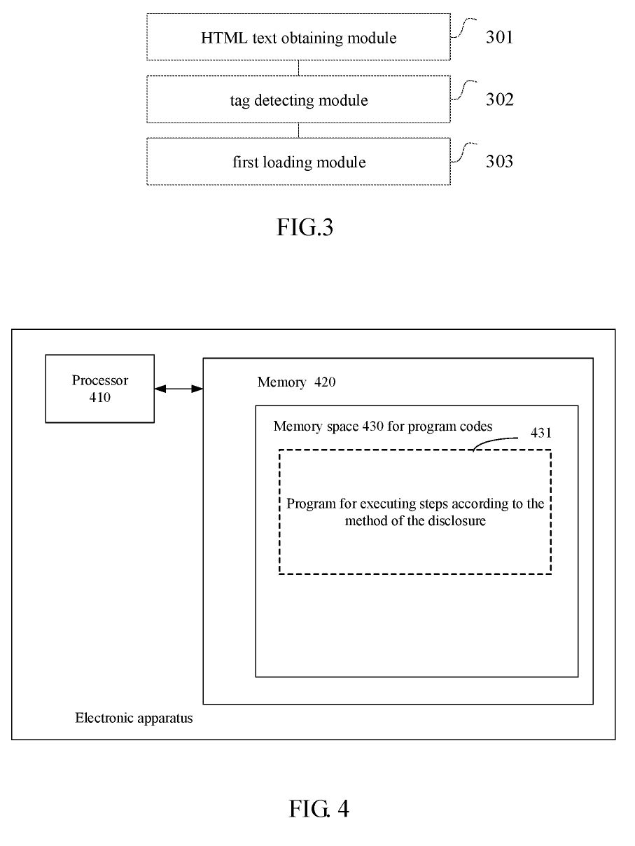

As shown in FIG. 3, it is a block diagram showing the device for performing webpage loading according to an embodiment of the disclosure. Which may include the following modules:
a HTML text obtaining module 301, configured to obtain HTML text of a current request-to-load webpage at a browser side;
a tag detecting module 302, configured to detect a tag for specifying a browser kernel included in the HTML text of the webpage;
a first loading module 303, configured to use the browser kernel specified by the tag to load the current requested webpage.

In a preferred embodiment of the disclosure, the tag for specifying browser kernel is a meta tag, the meta tag comprises a key value, which includes name information used as a key, and content information used as a value, the name information is configured to indicate information of the browser kernel, the content information is configured to indicate information for specifying the browser kernel.

In a preferred embodiment, the first loading module is further configured to:
extracting the content information of the meta tag;
determining whether a preset default browser kernel is the same as the browser kernel specified by the content information;
if yes, using the default browser kernel to load the current requested webpage;
if not, switching the default browser kernel to the browser kernel specified by the content information, and using the specified browser kernel to load the current requested webpage.

In a preferred embodiment, the device may further includes the following modules:
a request receiving module, configured to receive request information for loading the webpage;
an adaption relation module, configured to search an adaption relation between the webpage and the browser kernel according to a preset rule; when the adaption relation is found, selecting the corresponding browser kernel to load the webpage according to the adaption relation; when the adaption relation is not found, converting to the step of obtaining the HTML text of the current request-to-load webpage at the browser side;
a second loading module, configured to select corresponding browser kernel to load the webpage according to the adaption relation.

In a preferred embodiment, the adaption relation module is further configured to: obtain the browser kernel adapted to the request-to-load webpage according to the preset rule; the second loading module is further configured to: select the browser kernel adapted to the request-to-load webpage to load the webpage;
and/or,
the adaption relation module is further configured to: obtain the browser kernel not adapted to the request-to-load webpage according to the preset rule; the second loading module is further configured to: select browser kernel out of the browser kernel not adapted to the webpage to load the webpage.

The method also discloses a browser, which may include the following modules:
a HTML text obtaining module, configured to obtain HTML text of a current request-to-load webpage at a browser side;
a tag detecting module, configured to detect a tag for specifying a browser kernel included in the HTML text of the webpage;
a first loading module configured to use the browser kernel specified by the tag to load the current requested webpage.

In a preferred embodiment of the disclosure, the tag for specifying browser kernel is a meta tag, the meta tag comprises a key value, which includes name information used as a key, and content information used as a value, the name information is configured to indicate information of the browser kernel, the content information is configured to indicate information for specifying the browser kernel.

In a preferred embodiment, the first loading module is further configured to:
extracting the content information of the meta tag;
determining whether a preset default browser kernel is the same as the browser kernel specified by the content information;
if yes, using the default browser kernel to load the current requested webpage;
if not, switching the default browser kernel to the browser kernel specified by the content information, and using the specified browser kernel to load the current requested webpage.

In a preferred embodiment, the browser may further includes the following modules:
a request receiving module, configured to receive request information for loading the webpage;
an adaption relation module, configured to search an adaption relation between the webpage and the browser kernel according to a preset rule; when the adaption relation is found, selecting the corresponding browser kernel to load the webpage according to the adaption relation; when the adaption relation is not found, converting to the step of obtaining the HTML text of the current request-to-load webpage at the browser side;
a second loading module, configured to select corresponding browser kernel to load the webpage according to the adaption relation.

In a preferred embodiment, the adaption relation module is further configured to: obtain the browser kernel adapted to the request-to-load webpage according to the preset rule; the second loading module is further configured to: select the browser kernel adapted to the request-to-load webpage to load the webpage;
and/or,
the adaption relation module is further configured to: obtain the browser kernel not adapted to the request-to-load webpage according to the preset rule; the second loading module is further configured to: select browser kernel out of the browser kernel not adapted to the webpage to load the webpage.

Each of components according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the members of the device for webpage zooming on an electronic apparatus according to the embodiments of the disclosure. The disclosure may further be implemented as equipment or device programs (for example, computer programs and computer program products) for executing some or all of the methods as described herein. The programs for implementing the disclosure may be stored in the computer readable medium, or have a form of one or more signal. Such a signal may be downloaded from the internet websites, or be provided in carrier, or be provided in other manners.

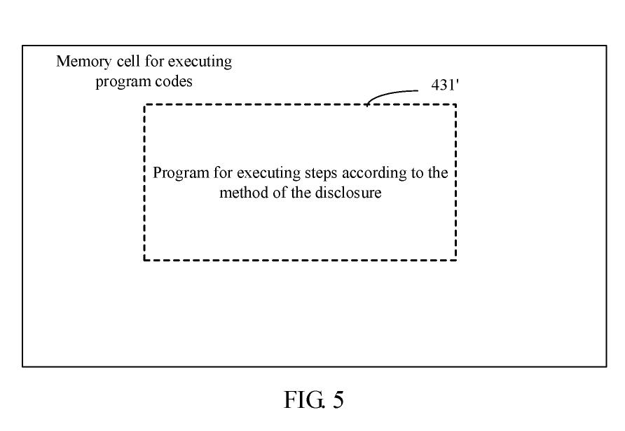

For example, FIG. 4 is a block diagram schematically illustrating an electronic apparatus for realizing webpage loading according the disclosure, such as an application server. Traditionally, the server includes a processor 410 and a computer program product or a computer readable medium in form of a memory 420. The memory 420 may be electronic memories such as flash memory, EEPROM (Electrically Erasable Programmable Read-Only Memory), EPROM, hard disk or ROM. The memory 420 has a memory space 430 for executing program codes 431 of respective steps in the above methods. For example, the memory space 430 for program codes may include respective program codes 431 for implementing the respective steps in the above mentioned method. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the server as shown in FIG. 4. The program codes may be compressed in an appropriate form. Usually, the memory cell includes computer readable codes 431′ which can be read by processors such as 410. When these codes are operated on the server, the server may execute respective step as described in the above method.

The “an embodiment”, “embodiments” or “one or more embodiments” mentioned in the disclosure means that the specific features, structures or performances described in combination with the embodiment(s) would be included in at least one embodiment. Moreover, it should be noted that, for example, the wording “in an embodiment” herein may necessarily not refer to the same embodiment.

Many details are discussed in the specification provided herein. However, it should be understood that the embodiments of the disclosure can be implemented without these specific details. In some examples, the well-known method, structure and technology are not illustrated in detail, so as to avoid an unclear understanding of the specification.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than for explaining or defining the subject matter of the disclosure. Therefore, it is obvious for an ordinary skilled person in the art that modifications and variations could be made without departing from the scope and spirit of the claims as appended. For the scope of the disclosure, the inventive disclosure is illustrative rather than restrictive, and the scope of the disclosure is defined by the appended claims.

1. A method for performing webpage loading, comprising:
obtaining HTML text of a current request-to-load webpage at a browser side;
detecting a tag for specifying a browser kernel included in the HTML text of the webpage;
using the browser kernel specified by the tag to load the current request-to-load webpage.

2. The method according to claim 1, wherein the tag for specifying the browser kernel is a meta tag, the meta tag comprises a key value, which includes name information used as a key, and content information used as a value, the name information is configured to indicate information of the browser kernel, the content information is configured to indicate information for specifying browser kernel.

3. The method according to claim 2, wherein the step of using the browser kernel specified by the tag to load the current request-to-load webpage comprises:
extracting the content information of the meta tag;
determining whether a preset default browser kernel is the same as the browser kernel specified by the content information;
if yes, using the default browser kernel to load the current request-to-load webpage;
if not, switching the default browser kernel to the browser kernel specified by the content information, and using the specified browser kernel to load the current request-to-load webpage.

4. The method according to claim 1, further comprising:
receiving request information for loading the webpage;
searching an adaption relation between the webpage and the browser kernel according to a preset rule;
when the adaption relation is found, selecting the corresponding browser kernel to load the webpage according to the adaption relation;
when the adaption relation is not found, converting to the step of obtaining the HTML text of the current request-to-load webpage at the browser side.

5. The method according to claim 4, wherein,
the step of searching the adaption relation between the webpage and the browser kernel according to the preset rule comprises: obtaining the browser kernel adapted to request-to-load webpage according to the preset rule; the step of selecting corresponding browser kernel to load the webpage according to the adaption relation comprises: selecting the browser kernel adapted to the request-to-load webpage to load the webpage;
and/or,
the step of searching the adaption relation between the webpage and the browser kernel according to the preset rule comprises: obtaining the browser kernel not adapted to the request-to-load webpage according to the preset rule; the step of selecting corresponding browser kernel to load the webpage according to the adaption relation comprises: selecting browser kernel out of the browser kernel not adapted to the webpage to load the webpage.

6. An electronic apparatus for performing webpage loading, comprising:
a memory having instructions stored thereon,
a processor configured to execute the instructions to perform operations for performing webpage loading, comprising:
obtaining HTML text of a current request-to-load webpage at a browser side;
detecting a tag for specifying a browser kernel included in the HTML text of the webpage;
using the browser kernel specified by the tag to load the current request-to-load webpage.

7. The electronic apparatus according to claim 6, wherein the tag for specifying browser kernel is a meta tag, the meta tag comprises a key value, which includes name information used as a key, and content information used as a value, the name information is configured to indicate information of the browser kernel, the content information is configured to indicate information for specifying the browser kernel.

8. The electronic apparatus according to claim 7, wherein in the using the browser kernel specified by the tag to load the current request-to-load webpage, the processor is further configured to perform:
extracting the content information of the meta tag;
determining whether a preset default browser kernel is the same as the browser kernel specified by the content information;
if yes, using the default browser kernel to load the current request-to-load webpage;
if not, switching the default browser kernel to the browser kernel specified by the content information, and using the specified browser kernel to load the current request-to-load webpage.

9. The electronic apparatus according to claim 6, wherein the processor is further configured to perform:
receiving request information for loading the webpage;
searching an adaption relation between the webpage and the browser kernel according to a preset rule; when the adaption relation is found, selecting the corresponding browser kernel to load the webpage according to the adaption relation; when the adaption relation is not found, converting to the step of obtaining the HTML text of the current request-to-load webpage at the browser side;
selecting corresponding browser kernel to load the webpage according to the adaption relation.

10. The electronic apparatus according to claim 9, wherein-in the searching an adaption relation between the webpage and the browser kernel according to a preset rule; when the adaption relation is found, selecting the corresponding browser kernel to load the webpage according to the adaption relation; when the adaption relation is not found, converting to the step of obtaining the HTML text of the current request-to-load webpage at the browser side, the processor is further configured to perform:
obtaining the browser kernel adapted to the request-to-load webpage according to the preset rule;
in the selecting corresponding browser kernel to load the webpage according to the adaption relation, the processor is further configured to perform: selecting the browser kernel adapted to the request-to-load webpage to load the webpage;
and/or,
in the searching an adaption relation between the webpage and the browser kernel according to a preset rule; when the adaption relation is found, selecting the corresponding browser kernel to load the webpage according to the adaption relation, when the adaption relation is not found, converting to the step of obtaining the HTML text of the current request-to-load webpage at the browser side, the processor is further configured to perform: obtaining the browser kernel not adapted to the request-to-load webpage according to the preset rule;
in the selecting corresponding browser kernel to load the webpage according to the adaption relation, the processor is further configured to perform: selecting browser kernel out of the browser kernel not adapted to the webpage to load the webpage.

11. A browser, comprising:
a HTML text obtaining module, configured to obtain HTML text of a current request-to-load webpage at a browser side;
a tag detecting module, configured to detect a tag for specifying a browser kernel included in the HTML text of the webpage;
a first loading module configured to use the browser kernel specified by the tag to load the current request-to-load webpage.

12. (canceled)

13. A non-transitory computer readable medium, having computer programs stored thereon that, when executed by one or more processors of an electronic apparatus, cause the electronic apparatus to perform:
obtaining HTML text of a request-to-load webpage at a browser side;
detecting a tag for specifying a browser kernel included in the HTML text of the webpage;
using the browser kernel specified by the tag to load the current request-to-load webpage.
